(19) United States
(12) Patent Application Publication
(10) Pub. No.: US 2023/0397752 A1
(43) Pub. Date: Dec. 14, 2023

(54) BEVERAGE INFUSING SYSTEMS

(71) Applicants: Sensio Inc., New York, NY (US); Sensio Inc., Montréal (CA)

(72) Inventors: Jorge B. Garcia, Rogers, AR (US); Keith Bilodeau, Plantsville, CT (US); Tristan McKeever, Montreal (CA)

(21) Appl. No.: 18/131,242

(22) Filed: Apr. 5, 2023

Related U.S. Application Data
(60) Provisional application No. 63/327,673, filed on Apr. 5, 2022.

(51) Int. Cl. A47J 31/44; A47J 31/00

(52) U.S. Cl. CPC A47J 31/44; B06B 1/16; A47J 31/002

(57) ABSTRACT

A beverage infuser assembly includes a fluid vessel including a top end and a bottom end. A longitudinal axis is defined between the top end and the bottom end. The beverage infuser assembly includes a base assembly to the bottom end of the fluid vessel. The beverage infuser device includes a vibration source positioned within the base. The vibration source is configured and adapted to transmit ultrasonic waves into the fluid vessel to accelerate the infusion process. A method for infusing a beverage with one or more ingredient includes actuating a vibration source positioned within a base of a beverage infuser. The method includes transmitting ultrasonic waves generated by the vibration source into a fluid vessel of the beverage infuser to accelerate infusion of one or more ingredient within the fluid vessel into a fluid within the fluid vessel.

### CROSS-REFERENCE TO RELATED APPLICATION

This application claims priority to U.S. Provisional Patent Application Ser. No. 63/327,673, filed Apr. 5, 2022, the contents of which are herein incorporated by reference in their entirety.

### BACKGROUND OF THE INVENTION

### Field of the Invention

The present disclosure relates to beverage makers and more particularly to beverage infusers that infuse a fluid with one or more ingredient.

### Description of Related Art

Traditional beverage infusers, such as those used for cold temperature infusion, typically include a fluid container, and a filtration device. The fluid container can hold water and an ingredient for infusing into the water. Once the infusion is complete, the filtration device allows for a user to separate the ingredient from the water or other fluid so that the fluid can be consumed. Beverage infusion processes under cold temperatures, such as cold-brew coffee, can take as much as 20 hours for full extraction. Similarly, infusion of fruit into water can take 4-5 hours. In some other beverage brewing systems, rotational and/or percolating flow is used to increase infusion. In these cases, however, infusion material must be a fine particulate.

Conventional techniques have been considered satisfactory for their intended purpose. However, there may be a need for improved beverage infusion, e.g., beverage infusion that can be performed faster. This disclosure provides a solution for this need.

### SUMMARY OF THE INVENTION

A beverage infuser assembly includes a fluid vessel including a top end and a bottom end. A longitudinal axis is defined between the top end and the bottom end. The beverage infuser assembly includes a base assembly to the bottom end of the fluid vessel. The beverage infuser device includes a vibration source positioned within the base. The vibration source is configured and adapted to transmit ultrasonic waves into the fluid vessel to accelerate the infusion process.

In certain embodiments, the beverage infuser includes an antenna positioned within the fluid vessel. It is contemplated that the antenna can be configured and adapted to amplify ultrasonic energy transfer. In some embodiments, the vibration source can be an electric motor. In some embodiments, the electric motor can be an eccentric rotating mass vibration motor.

It is contemplated that, in some embodiments, the fluid vessel can be removably coupled to the base assembly. In some embodiments, the beverage infuser can include a plunger assembly including a plunger rod having a first end and a second end. In some embodiments, the plunger assembly can include a plunger filter positioned on a second end of the plunger rod. In an infusion position, the plunger filter can be positioned more proximate the top end of the fluid vessel than the bottom end of the fluid vessel. In a pouring position, the plunger filter can be positioned more proximate the bottom end of the fluid vessel than the top end of the fluid vessel. In certain embodiments, the plunger assembly can include an antenna positioned between the plunger filter and the first end of the plunger rod.

In some embodiments, the base assembly can include an upper isolation platform, a lower housing and at least one elastomer element between the upper isolation platform and the lower housing. In certain embodiments, the upper isolation platform can be coupled to the elastomer element and the lower housing via a fastener. In some embodiments, the base assembly can include a mounting frame operatively coupled to the lower housing.

In certain embodiments, the beverage infuser can include at least one battery, wherein the battery is operatively connected to the mounting frame. In some embodiments, the base assembly can include an electric port configured and adapted to receive an electrical cord coupled to an external power source.

In some embodiments, the beverage infuser includes a controller operatively connected to the vibration source. The controller can be configured and adapted to vary the frequency of the ultrasonic waves emitted by the vibration source.

In some embodiments, the base assembly can include an upper isolation platform having a mounting portion. In some embodiments, the ultrasonic energy source can be mounted within the mounting portion of the isolation platform. It is contemplated that, in some embodiments, the fluid vessel can include a first threaded portion and the base assembly can include a second threaded portion. The first and second threaded portions can be configured and adapted to engage or disengage one another to allow for the fluid vessel to be removable from the base.

In accordance with another aspect, a method for infusing a beverage with one or more ingredient includes actuating a vibration source positioned within a base of a beverage infuser. The method includes transmitting ultrasonic waves generated by the vibration source into a fluid vessel of the beverage infuser to accelerate infusion of one or more ingredient within the fluid vessel into a fluid within the fluid vessel.

In some embodiments, the vibration source can be actuated for a time duration. The time duration can be set by application type, user input, or both. In some embodiments, the method can include sliding a plunger assembly to filter the at least one ingredient to one side of the fluid vessel.

In accordance with another aspect, a control system for a beverage infuser assembly includes a controller operatively connected to control a vibration source. The vibration source is configured and adapted to transmit ultrasonic waves into a fluid vessel to accelerate an infusion process. The controller is configured to vary the frequency of the ultrasonic waves based on at least one of user input, a predefined program, or both.

In some embodiments, the predefined program includes at least one of a respective type of infusion ingredient; a respective type of preparation for a respective type of infusion ingredient; or a respective timing for a respective type of preparation.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a side plan view of an embodiment of a beverage infuser assembly constructed in accordance with the present disclosure, showing the plunger in an infusion position;

FIG. 2 is a side plan view of the beverage infuser assembly of FIG. 1, showing the plunger in a pouring position;

FIG. 3 is a cross-sectional perspective view of the beverage infuser assembly of FIG. 1, showing the plunger in a pouring position; showing the vibration source and rechargeable battery;

FIG. 4 is an exploded perspective view of the of the beverage infuser assembly of FIG. 1, showing the upper isolation platform, the lower housing and elastomer elements, which are positioned between the upper isolation platform and the lower housing when assembled;

FIG. 5 is a cross-sectional perspective view of the of the beverage infuser assembly of FIG. 1, showing the assembly from a downward angle to show mounting portion that extends downward from the lower surface of the isolation platform; and

FIG. 6 is a partially exploded, partial cross-sectional perspective view of another embodiment of a beverage infuser assembly constructed in accordance with the present disclosure, showing an electrical cord operatively coupled to power the vibration source.

### DETAILED DESCRIPTION OF THE PREFERRED EMBODIMENTS

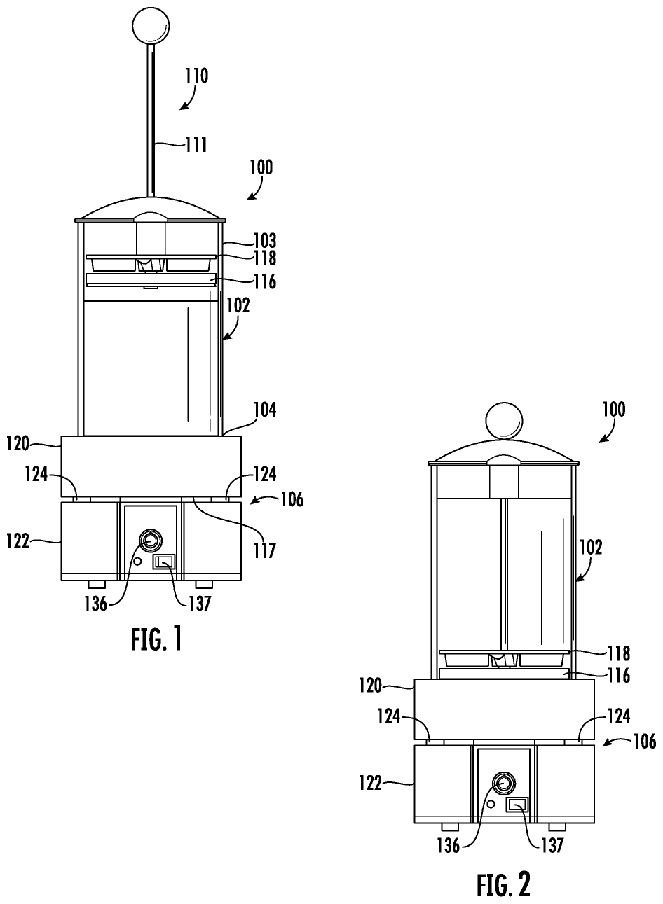

Reference will now be made to the drawings wherein like reference numerals identify similar structural features or aspects of the subject disclosure. For purposes of explanation and illustration, and not limitation, a schematic view of an exemplary embodiment of the beverage infuser assembly in accordance with the disclosure is shown in FIG. 1 and is designated generally by reference character 100. Other embodiments of beverage infuser assembly 100 in accordance with the disclosure, or aspects thereof, are provided in FIGS. 2-6 as will be described. The systems and methods described herein provide for an accelerated beverage infuser. The systems and methods described herein act to reduce the infusion time needed for preparing certain beverages, e.g., hot and cold coffee, hot and cold tea, fruit, herb, spice infused liquids, or the like, and any combination thereof.

As shown in FIGS. 1-2, a beverage infuser assembly 100 includes a fluid vessel 102 having a top end 103 and a bottom end 104. A longitudinal axis A is defined between top end 103 and a bottom end 104. Infuser assembly 100 includes a base assembly 106 operatively connected to bottom end 104 of fluid vessel 102. Base assembly 106 includes an upper isolation platform 120, a lower housing 122 and elastomer elements 124, e.g. rubber grommets, between upper isolation platform 120 and lower housing 122. Elastomer elements 124 act to provide noise isolation and vibration dampening to lower housing 122, described in more detail below.

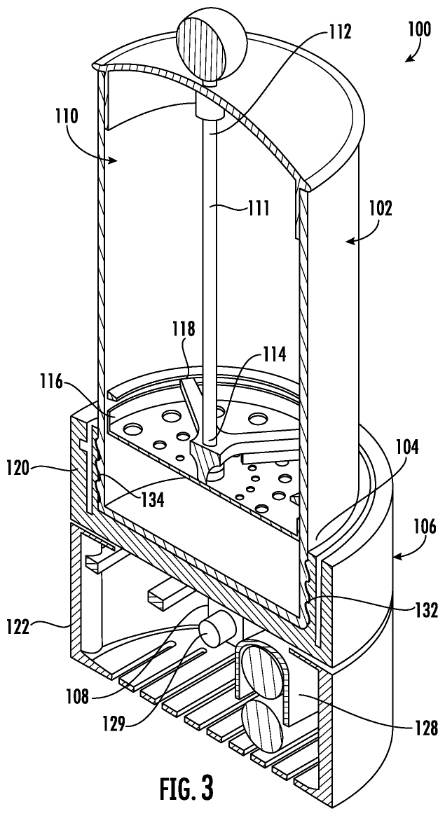

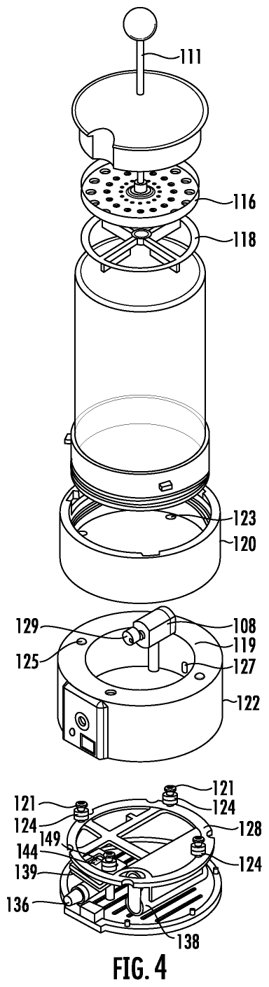

With reference now to FIGS. 3-4, fluid vessel 102 includes a first threaded portion 132 and base assembly 106 includes a second threaded portion 134. First and second threaded portions 132 and 134, respectively, are configured and adapted to engage or disengage one another to allow for fluid vessel 102 to be removable from base assembly 106. A vibration source 108 is positioned within base assembly 106. Vibration source 108 generates ultrasonic waves, e.g., those with a frequency of 20 kHz and higher, that are used to increase infusion. This is an advantage over other systems that may use rotational and/or percolating flow as the infusion ingredient does not have to be a fine particulate, it can be fruit infusion, for example. Overall, the expected improved extraction speed due to the ultrasonic energy provided is 30 to 50% faster than traditional units.

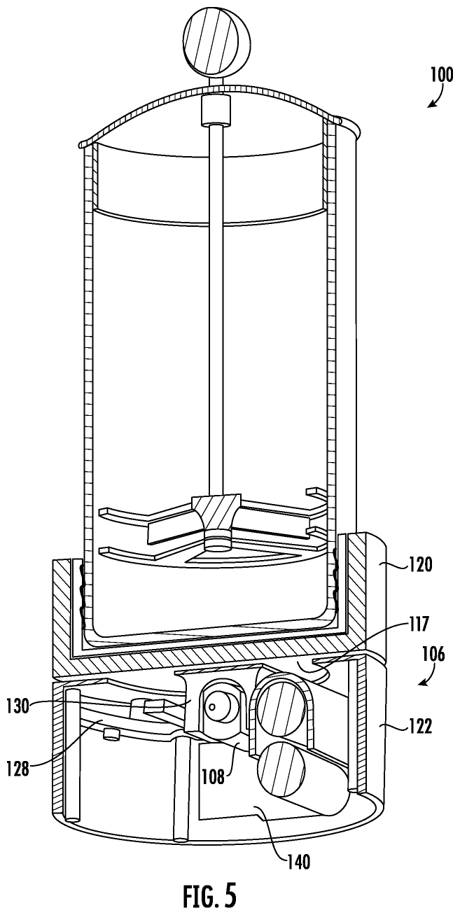

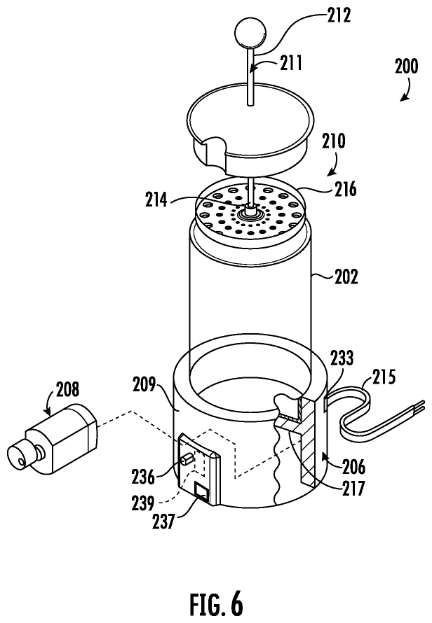

As shown in FIGS. 4-5, upper isolation platform 120 includes a mounting portion 130 that extends downward from a lower surface 117 of isolation platform 120. Vibration source 108 is mounted within mounting portion 130 of isolation platform 120. Elastomer elements 124 are positioned between lower surface 117 of isolation platform 120 and a top surface 119 of lower housing 122 and can be threaded into place by one or more fasteners 121 that are positioned through apertures 123 in isolation platform and corresponding apertures 125 in lower housing 122. Elastomer elements 124 positioned in this way act to provide noise isolation and vibration dampening to lower housing 122 by ensuring that the vibration generated by vibration source 108 is not transmitted to lower housing 122. Upper isolation platform 120 is coupled to each elastomer element 124 and lower housing 122 via respective fasteners 124.

With continued reference to FIGS. 4-5, base assembly 106 includes a mounting frame 128 operatively coupled to lower housing 122. Beverage infuser 100 includes at least one battery 138 mounted within a portion of mounting frame 128. Assembly 100 includes a battery charge controller printed circuit board (PCB) 140. Battery 138 is operatively connected to mounting frame 128. Battery is a rechargeable battery and allows for portability without the need for an external power source. Rechargeable battery 138 allows for the ability to infuse beverages within a cold environment (e.g., a refrigerator). Lower housing 122 can include a USB charging port 127, or the like, in order to provide power to rechargeable battery 138 during recharging. Those skilled in the art will readily appreciate that, in certain embodiments, instead of rechargeable battery, a corded electrical connection can be utilized with beverage infuser 100, similar to electrical cord 215, described below.

With continued reference to FIGS. 1-4, vibration source 108 is configured and adapted to transmit ultrasonic waves into fluid vessel to accelerate the infusion process. In the embodiment of FIGS. 1-2, vibration source 108 is an electric motor 108. Electric motor 108 is an eccentric rotating mass vibration motor having eccentric weight 129. Motor 108 with eccentric weight 129, provides ultrasonic energy into fluid vessel 102. Beverage infuser 100 includes an on/off switch 137 to turn electric motor 108 on or off. Beverage infuser 100 includes a dial 136 operatively coupled to electric motor 108 via control circuitry, e.g., on a PCB 139, in order to allow for the vibration strength of electric motor 108 to be adjusted depending on the type of desired infusion. PCB 139 includes a controller 144 operatively connected thereto or thereon.

As shown in FIG. 4, the controller 144 can be or include a motor controller configured to adjust the speed of motor 108 and/or the frequency of energy being input into assembly 100 based on a user selection on dial 136. The user selection can be a specific speed and/or frequency or be a pre-defined program. For example, depending on the desired application or type of ingredient, the frequency of vibration emitted by electric motor can range from 20 kHz and higher. Dial 136 and PCB 139 allow for a user to actively and precisely control extraction into liquids via antenna 118 and adjust the vibration frequency (traditional units in the market only control infusion strength by duration of the infusion cycle). PCB 139 can also include a time control function to stop after a certain duration of the switch being on. The controller 344 can include a memory 149, the memory 149 configured to store the predefined program. The predefined program includes at least one of a respective type of infusion ingredient, a respective type of preparation for a respective type of infusion ingredient, or a respective timing for a respective type of preparation.

With continued reference to FIGS. 1-4, beverage infuser includes a plunger assembly 110 including a plunger rod 111 having a first end 112 and a second end 114. Plunger assembly 110 includes a plunger filter 116 positioned on second end 114 of plunger rod 111. As shown in FIG. 1, in an infusion position, plunger filter 116 is positioned more proximate top end 103 of fluid vessel 102 than bottom end 104 of fluid vessel 102. Plunger filter 116 allows for filtering of infusion elements out of the beverage when process is complete. Plunger assembly 110 includes an antenna 118 positioned within fluid vessel 102 between plunger filter 116 and first end 112 of plunger rod 111. Antenna 118 is configured and adapted to amplify the ultrasonic energy transfer from motor 108 to facilitate efficient infusion. In a pouring position, as shown in FIG. 2, plunger filter 116 is positioned more proximate bottom end 104 of fluid vessel 102 than top end 103 of fluid vessel 102. In this way, plunger filter 116 pushes the ingredient (e.g. coffee grounds, fruit, tea leaves, or the like) toward the bottom end 104 of fluid vessel 102. This allows the infused fluid (which is not pushed downward) to be properly poured from fluid vessel 102.

As shown in FIG. 6, another embodiment of a beverage infuser assembly 200 is shown. Beverage infuser assembly 200 is similar to beverage infuser assembly 100 in that it includes a vibration source 208, similar to vibration source 108. Vibration source 208 is shown as an eccentric electric motor. But beverage infuser assembly 200 includes a fluid vessel 202 where a bottom end 204 is fixed to base assembly 206. Vibration source 208 is shown out of place for sake of clarity. As shown with broken lines in base 206, the vibration source would be operatively coupled to assembly 200 within base 206. Additionally, base assembly 206 includes an electric port 233 configured and adapted to receive an electrical cord 215 coupled to an external power source. In beverage infuser assembly 200, there is no antenna utilized, nor are there elastomeric elements, e.g., elastomeric elements 124, utilized in base assembly 206.

With continued reference to FIG. 6, the base assembly 206 includes a single housing 209, without a separate isolation platform and lower base. Housing 209 includes a support platform 217. Vibration source 208 is mounted to downward facing surface of support platform 217. A mounting portion, similar to mounting portion 130, can be used to mount vibration source 208 onto support platform 217. The functionality of vibration source 208 and reduced infusion time described for assembly 100 is the same as that for assembly 200. In some embodiments, beverage infuser 200 includes a dial 236 operatively coupled to electric motor 208 via a motor speed controller PCB 239 in order to allow for the vibration strength of electric motor 208 to be adjusted depending on the type of desired infusion, similar to dial 136 and PCB 139, described above. Assembly 200 may also include an on/off switch 237, similar to switch 137 described above. Those skilled in the art will readily appreciate that, in some embodiments of assemblies 100 or 200, dials 136 and 236 may not be included, and only on/off switches 137 and 237 may be used. Beverage infuser assembly 200 also includes a plunger assembly 210 including a plunger rod 211 having a first end 212 and a second end 214. Plunger assembly 210 includes a plunger filter 216 positioned on second end 214 of plunger rod 211. Plunger filter 216 is the same as plunger filter 116 and provides the same filtering function as described above for plunger filter 116.

In accordance with certain embodiments, a method for infusing a beverage with one or more ingredient includes actuating a vibration source, e.g., electric motor 108 or 208, positioned within a base assembly, e.g., base assembly 106 or 206, of a beverage infuser, e.g., beverage infuser 100 or 200. The method includes transmitting ultrasonic waves generated by the vibration source into a fluid vessel, e.g., fluid vessel 102 or 202, of the beverage infuser to accelerate infusion of one or more ingredient within the fluid vessel into a fluid within the fluid vessel. In certain embodiments, the vibration source is actuated, e.g., turned on, for 15 minutes. In some embodiments, the vibration source is actuated for 10-15 minutes, or 10-12 minutes. This actuation accelerates the infusion process of an ingredient into the fluid, reducing the time it takes for a user to make the desired infused beverage, e.g., cold-brew coffee, or the like. Once the infusion into the fluid is complete, the method includes sliding a plunger assembly, e.g., plunger assembly to filter the at least one ingredient to one side of the fluid vessel.

As will be appreciated by those skilled in the art, aspects of the present disclosure may be embodied as a system, method or computer program product. Accordingly, aspects of this disclosure may take the form of an entirely hardware embodiment, an entirely software embodiment (including firmware, resident software, micro-code, etc.), or an embodiment combining software and hardware aspects, all possibilities of which can be referred to herein as a “circuit,” “module,” or “controller.” A “circuit,” “module,” or “controller” can include one or more portions of one or more separate physical hardware and/or software components that can together perform the disclosed function of the “circuit,” “module,” or “controller”, or a “circuit,” “module,” or “controller” can be a single self-contained unit (e.g., of hardware and/or software). Furthermore, aspects of this disclosure may take the form of a computer program product embodied in one or more computer readable medium(s) having computer readable program code embodied thereon.

Those having ordinary skill in the art understand that any numerical values disclosed herein can be exact values or can be values within a range. Further, any terms of approximation (e.g., “about”, “approximately”, “around”) used in this disclosure can mean the stated value within a range. For example, in certain embodiments, the range can be within (plus or minus) 20%, or within 10%, or within 5%, or within 2%, or within any other suitable percentage or number as appreciated by those having ordinary skill in the art (e.g., for known tolerance limits or error ranges).

The articles “a”, “an”, and “the” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

Any suitable combination(s) of any disclosed embodiments and/or any suitable portion(s) thereof are contemplated herein as appreciated by those having ordinary skill in the art in view of this disclosure.

The methods and systems of the present disclosure, as described above and shown in the drawings, provide for improved beverage infusers with superior properties including reduced infusion time at room temperature or refrigerated temperature and reduced cost over traditional beverage infusers. The rechargeable battery allows for a smaller footprint, and portability. The systems and methods of the present invention can apply to cold-brew coffee, tea, or the like. While the apparatus and methods of the subject disclosure have been shown and described with reference to preferred embodiments, those skilled in the art will readily appreciate that changes and/or modifications may be made thereto without departing from the scope of the subject disclosure.

What is claimed is:

1. A beverage infuser assembly comprising:
a fluid vessel including a top end and a bottom end, defining a longitudinal axis between the top end and the bottom end;
a base assembly operatively connected to the bottom end of the fluid vessel; and
a vibration source positioned within the base, wherein the vibration source is configured and adapted to transmit ultrasonic waves into the fluid vessel to accelerate the infusion process.

2. The beverage infuser as recited in claim 1, further comprising an antenna positioned within the fluid vessel, the antenna configured and adapted to amplify ultrasonic energy transfer.

3. The beverage infuser as recited in claim 1, wherein the vibration source is an electric motor.

4. The beverage infuser as recited in claim 3 , wherein the electric motor is an eccentric rotating mass vibration motor.

5. The beverage infuser as recited in claim 1, wherein the fluid vessel is removably coupled to the base assembly.

6. The beverage infuser as recited in claim 1, further comprising a plunger assembly including a plunger rod having a first end and a second end, wherein the plunger assembly includes a plunger filter positioned on a second end of the plunger rod.

7. The beverage infuser as recited in claim 6, wherein, when in an infusion position, the plunger filter is positioned more proximate the top end of the fluid vessel than the bottom end of the fluid vessel.

8. The beverage infuser as recited in claim 6, wherein, when in a pouring position, the plunger filter is positioned more proximate the bottom end of the fluid vessel than the top end of the fluid vessel.

9. The beverage infuser as recited in claim 6, wherein the plunger assembly includes an antenna positioned between the plunger filter and the first end of the plunger rod.

10. The beverage infuser as recited in claim 1, wherein the base assembly includes an upper isolation platform, a lower housing and at least one elastomer element between the upper isolation platform and the lower housing.

11. The beverage infuser as recited in claim 10, wherein the upper isolation platform is coupled to the elastomer element and the lower housing via a fastener.

12. The beverage infuser as recited in claim 10, wherein the base assembly includes an mounting frame operatively coupled to the lower housing.

13. The beverage infuser as recited in claim 12, further comprising at least one battery, wherein the battery is operatively connected to the mounting frame.

14. The beverage infuser as recited in claim 1, wherein the base assembly includes an upper isolation platform having a mounting portion, wherein the ultrasonic energy source is mounted within the mounting portion of the isolation platform.

15. The beverage infuser as recited in claim 1, wherein the fluid vessel includes a first threaded portion and wherein the base assembly includes a second threaded portion, wherein the first and second threaded portions are configured and adapted to engage or disengage one another to allow for the fluid vessel to be removable from the base.

16. The beverage infuser as recited in claim 1, wherein the base assembly includes an electric port configured and adapted to receive an electrical cord coupled to an external power source.

17. The beverage infuser as recited in claim 1, further comprising a controller operatively connected to the vibration source, wherein the controller is configured and adapted to vary the frequency of the ultrasonic waves emitted by the vibration source.

18. A method for infusing a beverage with one or more ingredient, the method comprising:
actuating a vibration source positioned within a base of a beverage infuser; and
transmitting ultrasonic waves generated by the vibration source into a fluid vessel of the beverage infuser to accelerate infusion of one or more ingredient within the fluid vessel into a fluid within the fluid vessel.

19. The method as recited in claim 18, wherein the vibration source is actuated for a time duration, wherein the time duration is set by application type, user input, or both.

20. The method as recited in claim 18, further comprising sliding a plunger filter to filter the at least one ingredient to one side of the fluid vessel.

21. A control system for a beverage infuser assembly, the control system comprising,
a controller operatively connected to control a vibration source, wherein the vibration source is configured and adapted to transmit ultrasonic waves into a fluid vessel to accelerate an infusion process, wherein the controller is configured to vary the frequency of the ultrasonic waves based on at least one of user input, a predefined program, or both.

22. The control system of claim 21, wherein the predefined program includes at least one of:
a respective type of infusion ingredient;
a respective type of preparation for a respective type of infusion ingredient; or
a respective timing for a respective type of preparation.
